(19) United States
(12) Patent Application Publication
(10) Pub. No.: US 2025/0245661 A1
(43) Pub. Date: Jul. 31, 2025

(54) SYSTEMS AND METHODS FOR REAL-TIME CARDHOLDER AUTHENTICATION USING TRANSACTION HISTORY

(71) Applicant: Mastercard International Incorporated, Purchase, NY (US)

(72) Inventors: Julia Sciortino, Wingdale, NY (US); Disha Patel, Vadodara (IN); Prashanna Tiwaree, Castro Valley, CA (US)

(21) Appl. No.: 18/426,245

(22) Filed: Jan. 29, 2024

(51) Int. Cl. G06Q 20/40

(52) U.S. Cl. CPC G06Q 20/4014

(57) ABSTRACT

A system and method of authenticating a user during an enrollment event wherein the system is configure to receive an authentication request comprising a user's bank account data, using the user's bank account data, retrieve from a data warehouse, transaction history associated with said bank account data, execute one or more checks and clears on the user's transaction data and eliminating ineligible transactions, display multiple eligible transactions to a user on a user interface of a computing device, receive authenticating input, wherein the authenticating input comprises transaction identifying data, and generate a response to the request for authentication.

### BACKGROUND

### Field of the Invention

The present disclosure relates generally to systems and methods for real-time cardholder authentication and, more specifically, to systems and methods for real time cardholder authentication during an enrollment event using cardholder transaction history.

### RELATED ART

Cardholder authentication programs are security processes that protect third-party service providers by verifying a customer's identity during a payment transaction or an enrollment event. There are cardholder authentication programs for authenticating cardholder identities during enrollment events currently in existence. One method of cardholder authentication during an enrollment event requires cardholders to access their bank account online, possibly using a multifactor authentication method, and allow screen scraping in order to share data with the third-party providers.

Another method of cardholder authentication during an enrollment event includes micro deposits into the cardholder's bank account. The micro deposit process delays the authentication process while a cardholder awaits the appearance of the micro deposits in their bank account. For this reason, this method has higher levels of drop-off from cardholders. The micro deposit process is also an expensive method and requires that the third-party provider requesting authentication integrate with other third-party services.

What is needed, and what is disclosed herein, is a system and method for authenticating cardholders in real-time during an enrollment event using cardholder transaction history that eliminates password sharing and has higher levels of confidence.

### SUMMARY OF THE INVENTION

A system and method for real time cardholder authentication during an enrollment event a is described herein. Some embodiments of the system and method disclosed herein include receiving a request for authentication of a user; using a user's bank account data, retrieving from a data warehouse transaction history associated with said bank account data; executing one or more checks and clears on the user's transaction data to eliminate ineligible transactions; generating multiple eligible transactions for display to a user on a user interface of a computing device; receiving authenticating input, wherein the authenticating input comprises transaction identifying data; and generating a response to the request for authentication.

In some embodiments of the system and method disclosed herein, the user's transaction data is checked for the most recent transactions, and checked and cleared of recurring transactions, transactions with high-risk merchant category codes, and sensitive transaction category codes. In some embodiments, the transaction identifying data includes a merchant's name, transaction date, and amount spent.

### BRIEF DESCRIPTION OF THE DRAWINGS

The drawings described below are for illustrative purposes only and are not necessarily drawn to scale. The drawings are not intended to limit the scope of the disclosure in any way. Wherever possible, the same or like reference numbers are used throughout the drawings to refer to the same or like parts.

FIG. 1 is a block diagram of a system for real-time cardholder authentication using transaction history according to the embodiments disclosed herein; and

FIG. 2 is a flow chart illustrating a method for real-time cardholder authentication using transaction history according to the embodiments disclosed herein.

### DETAILED DESCRIPTION

As mentioned above, this disclosure relates generally to systems and methods for real-time cardholder authentication and, more specifically, to systems and methods for real time cardholder authentication during an enrollment event using cardholder transaction history.

The disclosed embodiments provide a means for third-party providers to authenticate cardholders (interchangeably referred to herein as users) during an enrollment event. Third-party providers may be merchants or other third-party providers of services, offers, or other benefits. By way of example, a third-party provider may be an insurance provider for high value purchases, loyalty or rewards programs, or corporate expense management services. Cardholders or users are owners of a payment card and/or bank account.

The system and method may be presented to a user through the use of an inline frame (iframe), allowing a user to access the system and method through the third-party provider's website, web application or mobile application. An iframe is an element that creates a nested browsing context, embedding an HTML page into another HTML page.

In other embodiments, the system may be implemented by the third-party providers through the use of application programming interfaces (APIs) facilitating the transfer of data between a financial institution and the third-party providers. An API is a set of instructions used to access certain features and data from other systems.

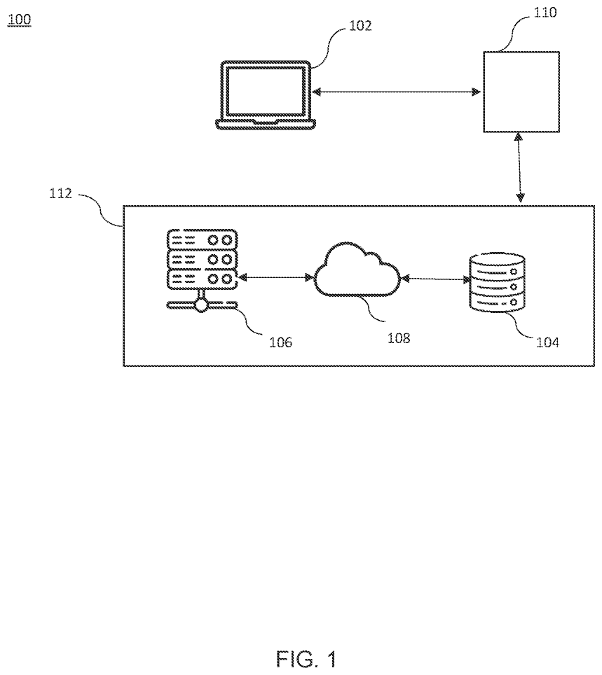

Turning to the figures, FIG. 1 is a block diagram of a system 100 for real-time cardholder authentication using transaction history data according to the embodiments disclosed herein. As shown in FIG. 1, the system 100 includes a user computing device 102, a data warehouse 104, a processor-based server 106, an electronic communications path 108 between the data warehouse 104 and the processor-based server 106, and a third-party provider 110. The processor-based server and the data warehouse may reside within a financial institution's network 112.

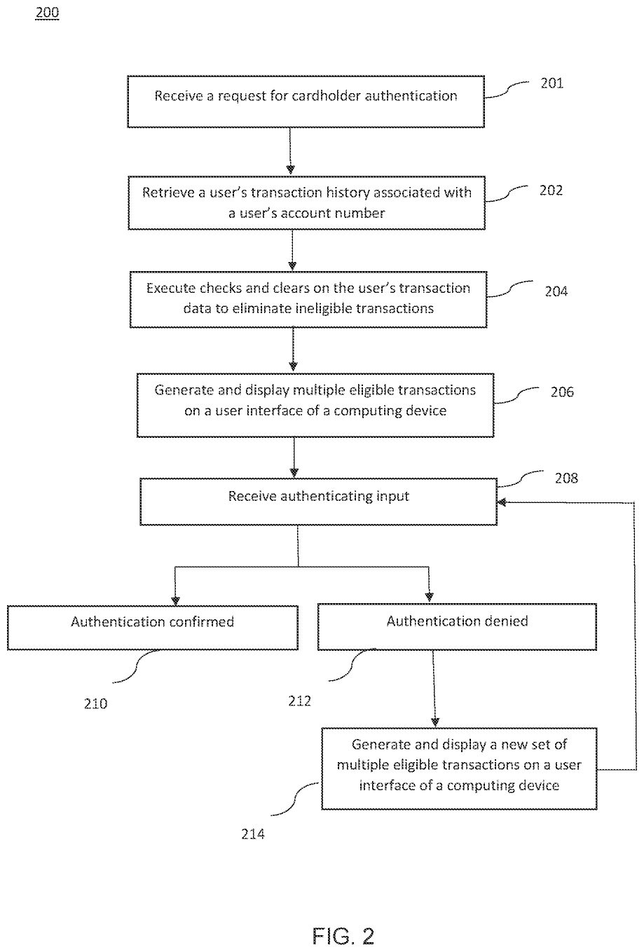

FIG. 2 is a flow chart illustrating a method 200 for real-time cardholder authentication using transaction history according to the embodiments disclosed herein. By way of a user interface on a computing device 102, the user engages in an enrollment event with a third-party provider 110. The user provides bank account data belonging to the user, preferably including at least the user's account number. The system receives a request for cardholder authentication 201. The computing device 102 may be a handheld device, laptop, desktop device, or other suitable computing device known in the art. The user's transaction history associated with the received account number is retrieved from the data warehouse 104 by a clearing API 202. The data warehouse 104 constructed by integrating data from multiple heterogeneous sources that support for analytical reporting, structured and/or ad-hoc queries, and decision making.

The processor-based server executes certain checks and clears on the user's retrieved transaction data to eliminate ineligible transactions 204. One of the purposes of the disclosed systems and methods is to eliminate the need for users to disclose sensitive information during an enrollment event such as passwords, healthcare transaction data, travel and location data and the like. As such, ineligible transactions may include transactions labeled with a transaction category code that may be deemed sensitive. Other types of ineligible transactions may include recurring transactions because they may be easier for a user to remember thereby reducing the reliability of the authentication; transactions with high-risk merchant category codes. Recurring transactions may include services provided under a subscription payment model such as Netflix, Spotify, Hulu, or other transactions that are predictable based on the limited number of services offered by the merchant. High-risk merchant category codes may be assigned to those transactions that are associated with higher levels of fraud and chargebacks and may also be tied to certain services and service providers.

The system may pull authorized transactions and/or cleared transactions. Where authorized transactions are pulled, transactions for amounts that are not yet finalized are ineligible.

There may be instances where a user may attempt authentication with an account that does not have any transactions or that does not have any eligible transactions. In these instances, authentication would be denied.

From the remaining transactions, multiple eligible transactions are displayed to a user on the user interface of a computing device 206. The user is then prompted to provide authenticating input 208. Authenticating input may include selection of genuine transaction data, entry of genuine transaction data, or a combination thereof. In preferred embodiments the user may select the name of the merchant through which a genuine transaction was made, the date of the transaction, and input the transaction amount.

The authenticating input is received and an authentication response is provided. If the authentication input accurately reflects genuine transaction data, the user authentication is confirmed 210. If the authenticating input does not accurately reflect genuine transaction data, the user authentication is denied 212. When a user authentication is denied, the user may be presented with a new set of eligible transactions to reattempt the authentication process 214.

To avoid fraud, each genuine transaction may only be presented to a user once and is thereafter deemed ineligible. In some embodiments of the present invention, users are presented with a limited number of attempts to receive authentication confirmation for a specific third-party provider. In some embodiments a user may be required to wait a specified length of time after they are denied authentication until they can reattempt to receive authentication confirmation.

They system and method may be used as a sole system and method of authentication or as an additional method of authentication.

1. A method of authenticating a user during an enrollment event, the method comprising the steps:
receiving an authentication request comprising a user's bank account data;
using the user's bank account data, retrieving from a data warehouse, transaction history data associated with said bank account data;
executing one or more checks and clears on the user's transaction history data and eliminating ineligible transactions;
displaying multiple eligible transactions to a user on a user interface of a computing device;
receiving authenticating input, wherein the authenticating input comprises transaction identifying data; and
generating a response to the request for authentication.

2. The method of claim 1, wherein the authenticating input comprising transaction identifying data includes a merchant's name, transaction date and transaction amount.

3. The method of claim 1, wherein the steps of receiving transaction history data and executing one or more checks and clears on the user's transaction data and eliminating ineligible transactions is executed by an application programming interface.

4. A system for authenticating a user during an enrollment event, the system comprising:
a data warehouse in electronic communication with a processor-based server capable of storing and retrieving data, the processor-based server configured to:
receive an authentication request comprising a user's bank account data;
using the user's bank account data, retrieve from the data warehouse, transaction history associated with said bank account data;
execute one or more checks and clears on the user's transaction data and eliminating ineligible transactions;
display multiple eligible transactions to a user on a user interface of a computing device;
receive authenticating input, wherein the authenticating input comprises transaction identifying data; and
generate a response to the request for authentication.

5. The system of claim 4, wherein the authenticating input comprising transaction identifying data includes a merchant's name, transaction date and transaction amount.

6. The system of claim 4, wherein the steps of receiving transaction history data and executing one or more checks and clears on the user's transaction data and eliminating ineligible transactions is executed by an application programming interface.
